(19) United States
(12) Patent Application Publication
(10) Pub. No.: US 2005/0127551 A1
(43) Pub. Date: Jun. 16, 2005

(54) Glass fiber sized web and process of making same

(75) Inventors: Haewon Uhm, Charlotte, NC (US); Leslie Horton, Madison, TN (US); Avi Desai, Brentwood, TN (US); William Bittle, Rock Hill, SC (US); Chuck Ford, Chester, SC (US); Betty Roberts, Chester, SC (US)

Correspondence Address: Attn: William J. Davis, Esq.;GAF MATERIALS CORPORATION, Legal Department, Building No. 10, 1361 Alps Road, Wayne, NJ, 07470, US

(73) Assignee: BUILDING MATERIALS INVESTMENT CORPORATION

(21) Appl. No.: 10/734,029

(22) Filed: Dec. 11, 2003

(51) Int. Cl. B27N 3/00

(52) U.S. Cl. 264/109

(57) ABSTRACT

A glass fiber web and a wet lay process of making the glass fiber web. The glass fibers of the web include glass fibers sized with a sizing composition which includes a partially amidated polyalkylene imine cationic lubricant randomly dispersed in a cured thermosetting resin. The wet lay process includes the steps of so sizing the glass fibers followed by separating such fibers by immersing the glass fibers in an aqueous dispersant medium to form an aqueous dispersion which is agitated. The separated sized glass fibers are dried. The dried, sized glass fibers are then bound with the thermosetting resin binder. The curing of the binder produces the product glass fiber web.

### BACKGROUND OF THE DISCLOSURE

1. Field of the Invention

The present invention is directed to a glass fiber web and a process of making that glass fiber web. More specifically, the present invention is drawn to a glass fiber web and a wet-lay process for making the web wherein the glass fibers are sized in a manner providing sufficient wet strength so that glass fibers on a drying conveyer can be transmitted to an adjacent binding conveyer without glass fiber dropout.

2. Background of the Prior Art

The standard process for preparing glass webs useful in many applications such as substrates in the formation of building materials, e.g. roofing membranes, high strength fabrics and the like, is the wet lay process. A major problem associated with the preparation of glass fiber mats by the wet lay process is the lack of strength of the wet individual glass fibers in the drying step prior to the binding step. That is, individual glass fibers disposed on a moving conveyer, subsequent to white water treatment, where substantial drying occurs, but prior to transfer to a downstream moving conveyer, where binding occurs, fall off the drying conveyer due to insufficient strength of the glass fibers.

A prior art method of overcoming this problem has been to provide a hiatus between the drying and binding steps. That is, the glass fibers, after separation in the white water treatment step, are allowed to dry for a few days before being binded into webs. Although this expedient is effective, it obviously markedly slows down the glass fiber web manufacturing process and is thus undesirable.

The above remarks, when taken with representative prior art summarized below, establish a strong need in the art for a new glass fiber web prepared by a wet lay process in which the strength of glass fibers have adequate strength so that the problem of loss of glass fibers between the drying and binding steps is overcome.

U.S. Pat. No. 4,871,605 describes a wet lay process for preparing a glass fiber mat useful as a roofing shingle. However, this patent does not address the aforementioned problem of the wet lay process of preparing fiber glass mats. This is all the more surprising insofar as a principal utility of glass fiber mats, prepared in accordance with the process of the '605 patent, is as a substrate in the formation of roofing shingles.

U.S. Pat. No. 6,228,281 sets forth a sizing composition for coating glass and carbon fibers. There is no disclosure in this patent of utilizing the sizing composition in a wet lay process.

### BRIEF SUMMARY OF THE INVENTION

A new glass fiber mat and a process of making that web has now been developed in which the glass fibers of the web are possessed of the requisite strength so that individual glass fibers are not lost, due to drop off, between the drying and binding steps, in a wet lay process of making a glass fiber mat.

In accordance with the present invention a glass fiber web is provided. The glass fiber web comprises glass fibers sized with a sizing composition which includes a partially amidated polyalkylene imine cationic lubricant randomly dispersed in a cured thermosetting resin.

In further accordance with the present invention a wet lay process is provided for preparing a glass fiber web. In this process glass fibers are sized with a sizing composition which includes a cationic lubricant, the cationic lubricant being a partially amidated polyalkylene imine. The sized glass fibers thus formed are separated by immersing the sized glass fibers in an aqueous dispersant medium wherein an aqueous slurry is formed. The resultant individual separated glass fibers are removed from the aqueous slurry and dried. The dried glass fibers are thereupon binded together by means of an uncured thermosetting binding agent. A glass fiber web is formed by curing the thermosetting binding agent.

### DETAILED DESCRIPTION

Glass fibers having a length of between about 0.25 inch and about 3 inches, preferably, between about 0.5 inch and about 2 inches, and more preferably, between about 1 inch and about 1.5 inches are employed in the glass fiber web of the present invention. The glass fibers within the scope of the present invention have a diameter of between about 10 microns and about 20 microns. More preferably, the glass fiber diameter is in the range of between about 13 microns and about 17 microns.

Glass fibers having the aforementioned dimensions are contacted with a sizing composition subsequent to glass fiber attenuation from a bushing apparatus. The sizing composition of the present invention includes a cationic lubricant which is a partially amidated polyalkylene imine having a preferred residual amine value of from about 200 to about 800. The partially amidated polyalkylene imines employed in the sizing composition are reaction products of a mixture of fatty acids containing between about 2 and about 18 carbon atoms and a polyethylene imine having a molecular weight of from about 800 to about 50,000. The amines suitable for forming the fatty acid salt of this reaction product are preferably tertiary amines of low molecular weight. For example, a preferred tertiary amine is a nitrogen atom attached to alkyl groups having from about 1 to about 6 carbon atoms. Preferably, the fatty acid moiety of the salt includes from about 12 to about 22 carbon atoms. More preferably, the partially amidated polyalkylene imine is a condensation reaction product of a polyethylene imine and a fatty acid selected from the group consisting of pelargonic and caprylic acids. An example of a cationic lubricant meeting the above criteria is Emery 6760T® available from Henkel Inc.

The concentration of the cationic lubricant in the sizing composition of the present invention is preferably in the range of between about 0.005% to about 0.20% by weight, based on the total weight of the sizing composition. The remaining constituency of the sizing composition is standard. That is, the sizing composition includes a film-forming polymer well known in the art for the coating of glass fibers. For example, film-forming polymers useful in the sizing composition of the present invention includes polyvinyl alcohols, polyvinyl acetates, epoxies, polyamides, polyesters, styrenated acrylics, phenolics, melamines, nylons, acrylics, polyvinyl chlorides, polyolefins, polyurethanes, nitrile rubbers and the like. Of these polymers, polyvinyl alcohols are particularly preferred.

The sizing composition also includes a coupling agent. The coupling agent employed in the sizing composition of the present invention has hydrolyzable groups that can react with the glass surface of the fibers to remove unwanted hydroxyl groups as well as groups that can react with the film-forming polymer to chemically link the polymer with the glass surface. Preferably, the coupling agent has one to three hydrolyzable functional groups that can interact with the surface of the glass fibers. In addition, the coupling agent includes one or more organic groups that are compatible with the polymer matrix.

Preferred coupling agents, useful in the sizing composition of the present invention, include organosilanes. Suffice it to say, the organosilanes useful in the sizing composition are preferably those that produce one to three hydroxyl groups for bonding at the inorganic glass surface to form O—Si—O bonds and which also possess at least one organic group for binding to the matrix resin. Preferred examples of organosilanes useful in the present invention include 3-amino-propyldimethylethoxysilane, γ-aminopropyltriethoxysilane, γ-aminopropyltrimethoxysilane, β-aminoethyltriethoxysilane, N-β-aminoethylaminopropyltrimethoxysilane, γ-isocyanatopropyltriethoxysilane, vinyl-trimethoxysilane, vinyl-triethoxysilane, allyl-trimethoxysilane, mercaptopropyltrimethoxysilane, mercaptopropyltriethoxysilane, glycidoxypropyltrimethoxysilane, 4,5-epoxycyclohexylethyltrimethoxysilane, ureidopropyltrimethoxysilane, ureidopropyltriethoxysilane, chloropropyltrimethoxysilane and chloropropyltriethoxysilane and mixtures thereof.

Additional lubricants can be added to the sizing composition to facilitate contact between the sizing composition and the glass fiber surface. Conventional lubricants known to those skilled in the art which are compatible with the components of the sizing composition of the present invention may be utilized. The concentration of the lubricants is usually small. A preferred lubricant is a fatty acid tallow amine such Cat-X®.

A hydrolyzing agent may also be included in the sizing composition. The hydrolyzing agent, which acts to hydrolyze the coupling agent or agents, is preferably an acid. Preferred hydrolyzing acids include hydrochloric, acetic, formic, citric, oxalic or phosphorous. Of these, acetic acid is more preferred.

The concentration of sizing composition provided onto the glass fiber is referred to as loss on ignition (LOI). The glass fiber employed in the glass fiber web of the present invention is characterized by a LOI in the range of between about 0.01% and about 0.75%, said percentages being by weight of the sizing composition, based on total weight of sized glass fibers free of water. More preferably, the LOI is in the range of between about 0.05% and about 0.5% by weight. Still more preferably, the LOI is in the range of between about 0.1% and about 0.2% by weight.

The thus formed sized glass fibers, in the form of chopped bundles, has a moisture content of about 10% to about 20%. These sized glass fibers are thereupon added to an aqueous dispersant medium to form an aqueous slurry. The aqueous dispersant includes an emulsifier to generate entrained air when the slurry is thereupon agitated. This entrained air imparts a white color to the slurry and thus the slurry is referred to as “white water.” This agitation of the aqueous slurry separates the glass fibers into individual strands.

The recovered individual glass fiber strands are thereupon dried. The drying step is effectuated by collecting the wet, sized glass fibers on an endless moving conveyer, the conveyer preferably being a wire screen. As the glass fibers move on the endless conveyer, they are heated and vacuumed to remove water. By the time the wet glass fibers traverse the length of the endless conveyer, the drying step is completed.

Immediately subsequent to the drying step, the binding step is initiated. This step involves transfer of the dried glass fibers, coming off the drying endless conveyer, onto an adjacent endless moving binding conveyer. It is at this point that the advantage of the present invention is manifested. In the past, an unacceptable percentage of glass fibers, if not allowed to dry for up to a few days after separation, fell into the space between the drying and binding conveyors. However, the sized glass fibers of the present invention attach to each other to provide the requisite strength so that glass fiber drop off is substantially reduced or eliminated between drying and binding conveyers.

The binding step, which occurs on the binding conveyer, involves application of a suitable thermosetting resin, which acts as the binder to the dried, sized glass fibers. The requisite amount of binder is preferably applied by curtain coating, which is the term used in the art for flooding, and vacuuming off the excess binder so that the desired binder concentration is obtained.

The binding resin, as stated above, is a thermosetting resin. Any suitable thermosetting resin, which is compatibly cured in the presence of glass fibers, may be utilized. In the interest of economy, a low cost thermosetting resin, such as urea formaldehyde, is preferred.

By the time glass fibers traverse the length of the binding endless conveyor, the desired concentration of glass fiber and binder is present. At this point the glass fiber-binder mixture is cured at a temperature at which the thermosetting resin crosslinks. Usually, this temperature is at least about 175° C.

The following examples are given to illustrate the present invention. Because these examples are given for illustrative purposes, the invention should hot be deemed limited thereto.

### EXAMPLE 1

A sizing composition was prepared comprising 0.1% polyvinyl alcohol; 0.02% ureidosilane; and 0.05% partially amidated polyalkylene amine, specifically, Emery 6760T®, wherein the percentages are by weight, based on the total weight of the composition. The remainder of the composition was water.

The aforementioned sizing composition was coated on a specially prepared glass fiber mat handsheet. The handsheet was thereupon moisture saturated and vacuumed. The handsheet was laid over a round opening and a load was placed on the handsheet so that the handsheet moved below the round opening. The load was increased until the handsheet reached a vertical distance of 24 mm below the round opening. The wet elongation strength was the weight of the load that is required to reach this distance. Obviously, the heavier the weight the stronger is the wet elongation strength.

It is apparent that the wetter the handsheet the less strong is the handsheet. The aforementioned test was conducted twice. The first test occurred on the day that the handsheet was moisture saturated. As such, testing on this day results in the maximum weight required since the saturated moisture content weakens glass fiber strength.

A second identical test was conducted three weeks later on the 21^{st} day after moisture saturation. During this 21 day period the glass fiber mat handsheet dries, reducing the moisture content and thus increasing wet elongation strength.

The results of this test was surprisingly found to be 153 grams on Day 1 and 149 grams on Day 21.

These results are summarized in the Table below.

### EXAMPLES 2-6

Five additional sizing compositions, employing the same components, albeit in varying concentrations, were prepared. These sizing compositions were applied, in the same concentration as in Example 1, to glass fiber mat handsheets identical to those used in Example 1. These handsheets were tested on Day 1 and Day 21 in a fashion identical to that employed in Example 1.

The results of these tests, including the constituency of the aqueous sizing compositions, are reported in the Table.

### COMPARATIVE EXAMPLE 1

Example 1 was repeated but for the constituency of the sizing composition. The sizing composition, although containing polyvinyl alcohol and ureidosilane, utilized a typical cationic lubricant of the prior art, instead of employing the partially amidated polyalkylene imine of the present invention. These components were included in the sizing composition in concentrations similar to the concentration of the examples of the present invention.

The results of the comparative example are included in the Table.

| | TABLE | | | | | | |
|---|---|---|---|---|---|---|---|
| | Example No. | | | | | | |
| | 1 | 2 | 3 | 4 | 4 | 4 | CE1 |
| Sizing Composition, | | | | | | | |
| % by wt | | | | | | | |
| Polyvinyl alcohol | 0.1 | 0.1 | 0.1 | 0.1 | 0.1 | 0.1 | |
| Ureidosilane | 0.02 | 0.02 | 0.02 | 0.04 | 0.04 | 0.04 | |
| Partially amidated | 0.05 | 0.1 | 0.15 | 0.05 | 0.1 | 0.15 | |
| polyalkylene imide | | | | | | | |
| Wet web strength, g. | | | | | | | |
| Day 1 | 153 | 152 | 166 | 166 | 155 | 158 | 68 |
| Day 21 | 149 | 151 | 143 | 154 | 145 | 137 | 106 |

### Discussion of Results

The wet strength handsheet test emulates the wet strength requirement of glass fibers moving from the drying conveyor to the binding conveyor. It is generally accepted that the wet strength requirement of glass fibers in moving from drying to binding conveyer is equivalent to a wet strength of approximately 100 grams, as determined in the aforementioned example.

The results of the above examples make it apparent that wet glass fibers, utilizing prior art sizing compositions, have to be stored up to 3 weeks in order to dry sufficiency to gain the requisite wet strength to successfully be processed. The sizing composition of the present invention eliminates this delay by increasing the wet strength of fully moisturized sized glass fibers such that no delay, occasioned by drying, is required before converting the glass fibers into glass fiber mats.

The above embodiments and examples are provided to illustrate the scope and spirit of the present invention. These embodiments and examples will make apparent, to those skilled in the art, other embodiments and examples. These other embodiments and examples are within the contemplation of the present invention. Therefore, the present invention should be limited only by the appended claims.

1. A wet lay process for preparing a glass fiber mat comprising the steps of:
(a) sizing glass fibers with a sizing composition which includes a partially amidated polyalkylene imine cationic lubricant;
(b) separating said sized glass fibers by immersing said sized glass fibers in an aqueous dispersant medium, whereby a slurry is formed;
(c) agitating said slurry;
(d) removing individual sized glass fibers from said aqueous slurry;
(e) drying said individual sized glass fibers;
(f) contacting said dried, sized glass fibers with a thermosetting binding resin; and
(g) curing said thermosetting resin whereby a glass fiber mat is formed.

2. A process in accordance with claim 1 wherein said partially amidated polyalkylene imine cationic lubricant comprises between about 0.005% and about 0.20% by weight, said percentages being by weight, based on the total weight of the sizing composition.

3. A process in accordance with claim 1 wherein said partially amidated polyalkylene imine has a residual amine value of from about 200 to about 800 and is the reaction product of fatty acids containing between about 2 and about 18 carbon atoms and a polyethylene imine having a molecular weight of from about 800 to about 50,000.

4. A process in accordance with claim 1 wherein said sized glass fibers have a loss on ignition in the range of between about 0.01% and about 0.75%.

5. A process in accordance with claim 4 wherein said sized glass fibers have a loss on ignition in the range of between about 0.05% and about 0.5%.

6. A process in accordance with claim 1 wherein said step (b) of separating said sized glass fibers occurs in the presence of an emulsifier to generate entrained air.

7. A process in accordance with claim 1 wherein said drying step (e) occurs on a endless moving conveyer.

8. A process in accordance with claim 7 wherein said binding step (f) occurs on an endless moving conveyer disposed adjacent to said endless moving conveyer employed in drying said dried sized glass fibers.

9. A process in accordance with claim 8 wherein said thermosetting binding resin is urea formaldehyde.

10. A process in accordance with claim 1 wherein said curing step (g) occurs by heating said product of step (f) at a temperature of at least about 175° C.

11. A glass fiber web comprising glass fibers sized with a sizing composition which includes a partially amidated polyalkylene imine cationic lubricant.

12. A web in accordance with claim 11 wherein said sized glass fibers are dispersed in a cured thermosetting resin.

13. A web in accordance with claim 12 wherein said partially amidated polyalkylene imine cationic lubricant comprises between about 0.005% and about 0.02%, said percentages being by weight, based on the total weight of the sizing composition.

14. A web in accordance with claim 13 wherein said sized glass fibers have a loss on ignition in the range of between about 0.01% and about 0.75%.

15. A web in accordance with claim 14 wherein said sized glass fibers have a loss on ignition in the range of between about 0.05% and about 0.5%.

16. A web in accordance with claim 15 wherein said sized glass fibers have a loss on ignition in the range of between about 0.1% and about 0.2%.

17. A web in accordance with claim 14 wherein said partially amidated polyalkylene imine has a residual amine value of from about 200 to about 800 and is the reaction product of fatty acids containing between about 2 and about 8 carbon atoms and a polyethylene imine having a molecular weight of from about 800 to about 50,000.

18. A web in accordance with claim 11 wherein said cured thermosetting resin is cured urea formaldehyde.
